(19) United States
(12) Patent Application Publication
(10) Pub. No.: US 2015/0006743 A1
(43) Pub. Date: Jan. 1, 2015

(54) TRANSMISSION MANAGEMENT DEVICE, SYSTEM, AND METHOD

(71) Applicant: POWER-ALL NETWORKS LIMITED, SHATIN (HK)

(72) Inventor: STEVE LAP WAI HUI, Shatin (HK)

(21) Appl. No.: 14/315,579

(22) Filed: Jun. 26, 2014

(30) Foreign Application Priority Data
Jun. 27, 2013 (CN) 2013102619859

(51) Int. Cl. H04L 29/06

(52) U.S. Cl. CPC H04L 65/1069
USPC 709/227

(57) ABSTRACT

A transmission management method includes detecting a data size of a media file when a first electronic device transmits the media file to a second electronic device. A leased transmission path is established between the first electronic device and the second electronic device. The first electronic device and the second electronic device are used to communicate with each other via the leased transmission path when the data size of the media file is greater than a predetermined value.

### CROSS-REFERENCE TO RELATED APPLICATIONS

This application claims priority to Chinese Patent Application No. 201310261985.9 filed on Jun. 13, 2013 in the China Intellectual Property Office, the contents of which are incorporated by reference herein.

1. “TRANSMISSION MANAGEMENT DEVICE, SYSTEM, AND METHOD” by Steve Lap Wai Hui, whose Attorney Docket No is US52358.

2. “TRANSMISSION MANAGEMENT DEVICE, SYSTEM, AND METHOD” by Steve Lap Wai Hui, whose Attorney Docket No is US52359.

3. “TRANSMISSION MANAGEMENT DEVICE, SYSTEM, AND METHOD” by Steve Lap Wai Hui, whose patent application Ser. No. is 14/278640, filed on May 15, 2014, related to a method for establishing a leased/optimal transmission path.

4. “TRANSMISSION MANAGEMENT DEVICE, SYSTEM, AND METHOD” by Steve Lap Wai Hui, whose patent application Ser. No. is 14/278640, filed on May 15, 2014, related to a method for establishing a leased/optimal transmission path.

5. “TRANSMISSION MANAGEMENT DEVICE, SYSTEM, AND METHOD” by Steve Lap Wai Hui, whose patent application Ser. No. is 14/278685, filed on May 15, 2014, related to a method for establishing a leased/optimal transmission path.

6. “TRANSMISSION MANAGEMENT DEVICE, SYSTEM, AND METHOD” by Steve Lap Wai Hui, whose patent application Ser. No. is 14/278704, filed on May 15, 2014, related to a method for establishing a leased/optimal transmission path.

### FIELD

The present disclosure relates to devices, and particularly to a transmission management device, a system, and a method thereof.

### BACKGROUND

Electronic devices, such as mobile phones and tablet computers, are popular. Usually, the electronic devices can communicate with each other and access to a network via corresponding networks, such as Internet, a code division multiple access (CDMA) network, or a broadcasting network. However, in some situations, when electronic devices connect to networks according to a certain network bandwidth assigned by a corresponding network operator, and when the number of people accessing the network is great, the resulting access speed can be very slow.

### BRIEF DESCRIPTION OF THE DRAWINGS

Implementations of the present technology will now be described, by way of example only, with reference to the attached figures.

FIG. 1 is a block diagram of an embodiment of a transmission management device.

FIG. 2 is a flowchart diagram of an embodiment of a transmission management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

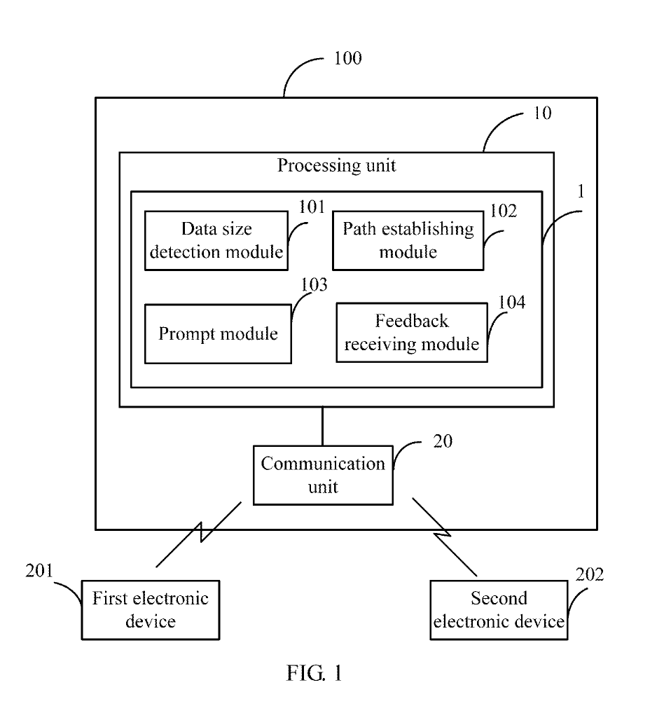

FIG. 1 illustrates a transmission management device 100 of the disclosure. The transmission management device 100 includes a processing unit 10 and a communication unit 20.

The transmission management device 100 connects to at least one first electronic device 201 and at least one second electronic device 202 via the communication unit 20. The transmission management device 100 connects to the first electronic device 201 and the second electronic device 202 via corresponding networks, such as, internet, a wireless network including WIFI and BLUETOOTH®, a telecommunication network including a general packet radio service (GPRS) network and a code division multiple access (CDMA) network, or a broadcasting network.

In the embodiment, the processing unit 10 can run a transmission management system 1. The transmission management system 1 includes a number of modules, which are a collection of software instructions and are executed by the processing unit 10 of the transmission management device 100. The modules include a data size detection module 101 and a path establishing module 102. In the embodiment, the processing unit 10 can be for example, a central processing unit, a digital signal processor, or a single chip.

In the embodiment, the first electronic device 201 initiates communication with the second electronic device 202.

The data size detection module 101 is used to detect a data size of a media file when the first electronic device 201 transmits the media file to the second electronic device 202. The media file can be for example, an audio file, a video file, a word file, or an image.

The path establishing module 102 is used to establish a leased transmission path between the first electronic device 201 and the second electronic device 202, and controls the first electronic device 201 and the second electronic device 202 to communicate with each other via the leased transmission path when the data size detection module 101 detects the data size of the media file is greater than a predetermined value, such as 100 Megabits.

In the embodiment, the leased transmission path can be an on-demand virtual lease line (ODVLL) and can enhance a transmission speed. In more detail, the leased transmission path are constituted by a number of routers (not shown) connected between the first electronic device 201 and the second electronic device 202. The related technology of establishing the leased transmission path by the path establishing module 102 are disclosed in prior patent applications whose patent application Ser. Nos. are 14/278640, 14/278640, 14/278685, and 14/278704.

In the embodiment, the transmission management system 1 further includes a prompt module 103 and a feedback receiving module 104.

The prompt module 103 is used to transmit a prompt signal to the second electronic device 202 to prompt a user of the second electronic device 202 to use the leased transmission path, when the data size detection module 101 detects the data size of the media file is greater than the predetermined value.

The feedback receiving module 104 is used to receive a feedback signal from the second electronic device 202. In the embodiment, the feedback signal includes a reply to the prompt signal, such as “Yes” or “No”.

If the path establishing module 102 determines the user wants to use the leased transmission path according to the feedback signal, namely the feedback signal is “Yes”, the path establishing module 102 then establishes the leased transmission path between the first electronic device 201 and the second electronic device 202. Here, the prompt module 103 and the feedback receiving module 104 can be omitted.

In the embodiment, the path establishing module 102 is further used to cancel the leased transmission path between the first electronic device 201 and the second electronic device 202 when the media file is transmitted to the second electronic device 202 completely. In the embodiment, the path establishing module 102 further records a start time when establishing the leased transmission path and an end time when cancelling the leased transmission path after the leased transmission path is canceled.

In another embodiment, the prompt signal produced by the prompt module 103 further includes a prompt for selecting the start time and the end time of the leased transmission path. The feedback signal received by the feedback receiving module 104 further includes the start time and the end time of the leased transmission path selected by the user of the second electronic device 202. Therefore, the path establishing module 102 can establish the leased transmission path when a current time reaches the start time selected by the user and cancel the leased transmission path when the current time reaches the end time selected by the user.

Thus, when the data size of the media file is huge (for example, greater than 100 Megabits), the present disclosure can provide the leased transmission path to transmit the media file, which enhances the transmission speed.

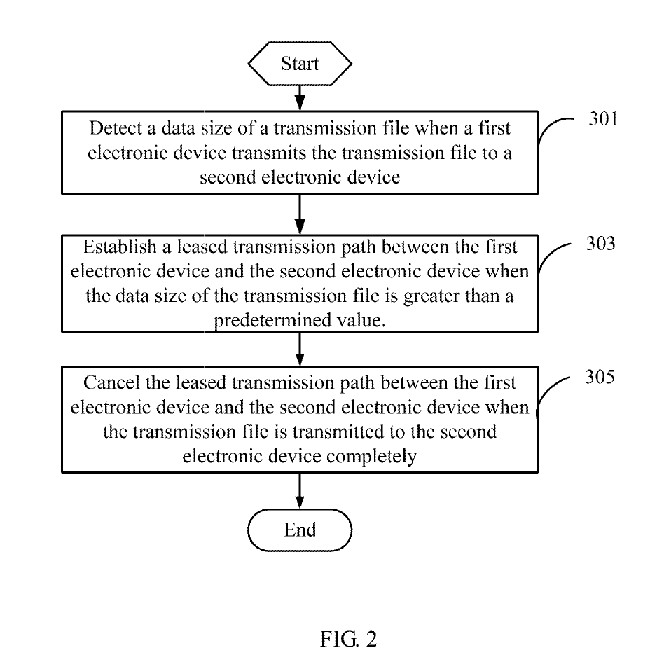

FIG. 2 illustrates a flowchart of a transmission management method. In block 301, a data size detection module detects a data size of a media file when a first electronic device transmits the media file to a second electronic device.

In block 303, a path establishing module establishes a leased transmission path between the first electronic device and the second electronic device and controls the first electronic device and the second electronic device to communicate with each other via the leased transmission path, when the data size detection module detects the data size of the media file is greater than a predetermined value.

In block 305, the path establishing module cancels the transmission path between the first electronic device and the second electronic device when the media file is transmitted to the second electronic device completely.

In another embodiment, the method further includes: a prompt module transmits a prompt signal to the second electronic device to prompt a user of the second electronic device to use the leased transmission path, when the data size detection module detects the data size of the media file is greater than the predetermined value; and a feedback receiving module receives a feedback signal from the second electronic device, and if the path establishing module determines the user wants to use the transmission path according to the feedback signal, namely the feedback signal is “Yes”, the path establishing module then establishes the transmission path between the first electronic device and the second electronic device.

In another embodiment, the method further includes: the path establishing module records a start time and an end time when the leased transmission path being established after the leased transmission path is canceled.

In another embodiment, the prompt signal produced by the prompt module further includes a prompt for selecting the start time and the end time of the transmission path, and the feedback signal received by the feedback receiving module further includes the start time and the end time of the transmission path selected by the user of the second electronic device. The method further includes: the path establishing module establishes the transmission path when a current time reaches the start time selected by the user and cancels the transmission path when the current time reaches the end time selected by the user.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission management system, applied to a transmission management device comprising a communication unit for connecting to at least one first electronic device and at least one second electronic device, the transmission management system comprising:
a processing unit; and
a plurality of modules which are collections of instructions executed by the processing unit, the modules comprising:
a data size detection module configured to detect a data size of a media file when a first electronic device transmits the media file to a second electronic device; and
a path establishing module configured to establish a leased transmission path between the first electronic device and the second electronic device and controls the first electronic device and the second electronic device to communicate with each other via the leased transmission path when the data size detection module detects the data size of the media file is greater than a predetermined value.

2. The system according to claim 1, wherein the path establishing module is further configured to cancel the leased transmission path between the first electronic device and the second electronic device when the media file is transmitted to the second electronic device completely.

3. The system according to claim 2, wherein the path establishing module is further configured to record a start time and an end time of the leased transmission path being established after the leased transmission path is canceled.

4. The system according to claim 1, wherein the transmission management system further comprises a prompt module and a feedback receiving module; the prompt module is configured to transmit a prompt signal to the second electronic device to prompt a user of the second electronic device whether to use the leased transmission path, when the data size detection module detects the data size of the media file is greater than the predetermined value; the feedback receiving module is configured to receive a feedback signal from the second electronic device; and the path establishing module establishes the leased transmission path between the first electronic device and the second electronic device when determining the user want to use the leased transmission path according to the feedback signal.

5. The system according to claim 4, wherein the prompt signal produced by the prompt module further comprises a prompt for selecting the start time and the end time of the leased transmission path, and the feedback signal received by the feedback receiving module further comprises the start time and the end time of the leased transmission path selected by the user of the second electronic device; the path establishing module is further configured to establish the leased transmission path when a current time reaches the start time selected by the user and cancel the leased transmission path when the current time reaches the end time selected by the user.

6. A transmission management device comprising:
a communication unit configured to communicate with at least one first electronic device and at least one second electronic device; and
a processing unit configured to execute a plurality of modules which are collection of instructions, the modules comprising:
a data size detection module configured to detect a data size of a media file when a first electronic device transmits the media file to a second electronic device; and
a path establishing module configured to establish a leased transmission path between the first electronic device and the second electronic device and controls the first electronic device and the second electronic device to communicate with each other via the leased transmission path, when the data size detection module detects the data size of the media file is greater than a predetermined value.

7. The device according to claim 6, wherein the path establishing module is further configured to cancel the leased transmission path between the first electronic device and the second electronic device when the media file is transmitted to the second electronic device completely.

8. The device according to claim 7, wherein the path establishing module is further configured to record a start time and an end time of the leased transmission path being established after the leased transmission path is canceled.

9. The device according to claim 6, wherein the modules further comprises a prompt module and a feedback receiving module, the prompt module is configured to transmit a prompt signal to the second electronic device to prompt a user of the second electronic device whether to use the leased transmission path, when the data size detection module detects the data size of the media file is greater than the predetermined value; the feedback receiving module is configured to receive a feedback signal from the second electronic device; and the path establishing module establishes the leased transmission path between the first electronic device and the second electronic device when determining the user want to use the leased transmission path according to the feedback signal.

10. The device according to claim 9, wherein the prompt signal produced by the prompt module further comprises a prompt for selecting the start time and the end time of the leased transmission path, and the feedback signal received by the feedback receiving module further comprises the start time and the end time of the leased transmission path selected by the user of the second electronic device; the path establishing module is further configured to establish the leased transmission path when a current time reaches the start time selected by the user and cancel the leased transmission path when the current time reaches the end time selected by the user.

11. A transmission management method comprising:
detecting a data size of a media file when a first electronic device transmits the media file to a second electronic device; and
establishing a leased transmission path between the first electronic device and the second electronic device and controlling the first electronic device and the second electronic device to communicate with each other via the leased transmission path, when the data size of the media file is greater than a predetermined value.

12. The method according to claim 11, further comprising:
cancelling the leased transmission path between the first electronic device and the second electronic device when the media file is transmitted to the second electronic device completely.

13. The method according to claim 12, further comprising:
recording a start time and an end time of the leased transmission path being established after the leased transmission path is canceled.

14. The method according to claim 12, further comprising:
transmitting a prompt signal to the second electronic device to prompt a user of the second electronic device whether to use the leased transmission path, when the data size of the media file is greater than the predetermined value;
receiving a feedback signal from the second electronic device; and
establishing the leased transmission path between the first electronic device and the second electronic device when determining the user want to use the leased transmission path according to the feedback signal.

15. The method according to claim 14, wherein the prompt signal produced by the prompt module further comprises a prompt for selecting the start time and the end time of the leased transmission path, and the feedback signal received by the feedback receiving module further comprises the start time and the end time of the leased transmission path selected by the user of the second electronic device; the method further comprises:
establishing the leased transmission path when a current time reaches the start time selected by the user and cancelling the leased transmission path when the current time reaches the end time selected by the user.
